(19) United States
(12) Patent Application Publication
(10) Pub. No.: US 2009/0200836 A1
(43) Pub. Date: Aug. 13, 2009

(54) GUSSETED TORSION SYSTEM FOR AN OPEN FRAME VEHICLE

(76) Inventors: Aaron Alls, Ventura, CA (US); Joseph Beck, Oxnard, CA (US); Bruce W. Farber, Oxnard, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/029,872

(22) Filed: Feb. 12, 2008

(51) Int. Cl. B62D 21/03

(52) U.S. Cl. 296/204

(57) ABSTRACT

A gusseted torsion system minimizes torsional deflection in an open frame vehicle having a generally U-shaped frame with two generally parallel beams. The gusseted torsion system includes cross members extending between the parallel beams and gussets adjacent each end of the cross members. The gussets are affixed to the parallel beams to counter torsional forces created by loads exerted on the parallel beams.

### FIELD OF THE INVENTION

The present invention relates to an externally gusseted torsion control system for controlling twist in an open frame vehicle. More particularly, the invention relates to a system for controlling twist in frame members of a boat lifting and stacking vehicle.

### BACKGROUND OF THE INVENTION

Boat storage facilities continue to experience an increased demand in storage space due to an increase in boat ownership. Additionally, the shortage and high price of waterfront land increases the need for offshore boat storage facilities. These boat storage facilities are the equivalent of large warehouses where owners endeavor to optimize storage and warehouse space in order to obtain a premium value from the land. Thus, boats are stored on racks stretching horizontally and vertically throughout the storage facility.

To further maximize profitability and utilization of space, owners attempt to position the racks as closely as possible minimizing the aisle space between racks. In order to navigate the narrow aisles between racks a novel open frame boat lifting and stacking vehicle has been devised. This open frame boat lifting and stacking vehicle described in U.S. application Ser. No. 11/877,174 comprises an elongated frame having parallel side rails and a carriage movable along the length of the rails. The carriage carries an upright forklift mast and an operator console. The elongated frame is in the shape of a U with the parallel side rails forming the arms of the U-shape and a rigid back plate at the rear of the vehicle forming the base of the U. The portion of the frame near the front of the vehicle is open.

As the carriage moves along the side rails the weight of the carriage thereon combined with the distance from the rigid back plate creates torsion in the rails such that the top of each rail is rotated inwardly toward the open area of the frame.

Accordingly, there is a need for a system to counter torsion forces in load bearing members of an open frame vehicle. The present invention fulfills these needs and provides other related advantages.

### SUMMARY OF THE INVENTION

The present invention is directed to a gusseted torsion system for an open frame vehicle. The torsion system acts on a generally U-shaped frame having two generally parallel, load bearing beams and a back plate, the beams and back plate defining an open area. A cross member extends between the beams below the open area. A gusset is positioned adjacent to each of the two ends of the cross member and affixed to either a first side or an opposite second side of each of the parallel beams.

The gussets act counter to torsion forces on the beams resulting from the load borne thereon. The vehicle includes wheel support structures on the first side of each of the parallel beams. Load bearing members in the form of guide rails are on the opposite second side of each beam. In a preferred embodiment, the first side is an external side of the beams or U-shaped frame and the opposite second side is an internal side of the beams or U-shaped frame.

In this preferred embodiment the gussets are affixed to the external side of the beams. A carriage mounted on the load bearing members is movable along the members from a back end of the beams to a front end of the beams and vice versa. The downward force from this carriage on the load bearing members creates a rotational or torsion force on each of the beams which causes the top of each beam to twist inward toward the center of the frame.

The back plate is rigidly connected to the back end of each of the beams. This rigid connection with the back plate counters the torsion forces at the back end of each of the beams. The gussets are rigidly connected to each of the cross members at a ninety degree angle and comprise a vertical plate securely connected to the first side or second side of the beams. This rigid connection between the gussets and the beams counters the torsion forces along the length of the beams. The gussets further comprise a perpendicular gusset that anchors the vertical plate to the adjacent cross member end. The perpendicular gusset provides additional support to resist the torsional forces.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a boat lifting and stacking vehicle having the gusseted torsion system of the present invention;

FIG. 2 is another perspective view of a boat lifting and stacking vehicle having the gusseted torsion system of the present invention;

FIG. 3 is a rear perspective view of a boat lifting and stacking vehicle having the gusseted torsion system of the present invention;

FIG. 4 is a close-up view of a gusset according to the present invention;

FIG. 5 is a close-up view of an anchor on the rigid back plate;

FIG. 6 illustrates a cross member and gusset according to the present invention;

FIG. 7 illustrates a back plate and anchors according to the present invention;

FIG. 8 is a free body diagram of a cross-section of a load bearing beam of the present invention illustrating the forces exerted thereon; and

FIG. 9 is a free body diagram of a cross-section of a load bearing beam of the present invention illustrating the countering torsion forces exerted thereon.

### DETAILED DESCRIPTION OF THE PREFERRED EMBODIMENT

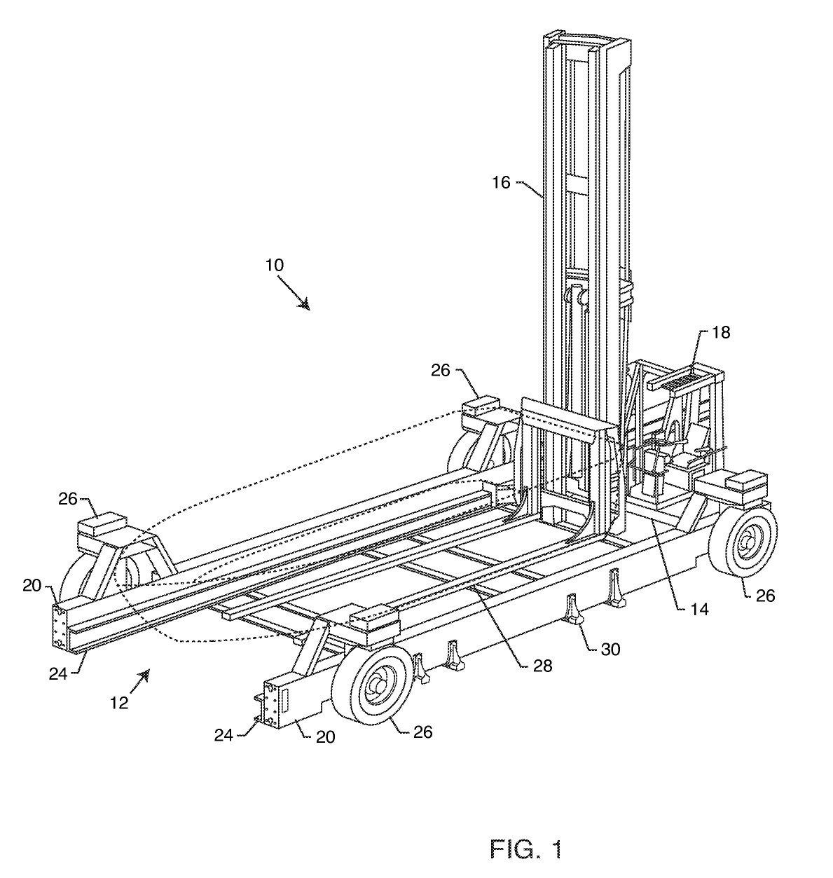

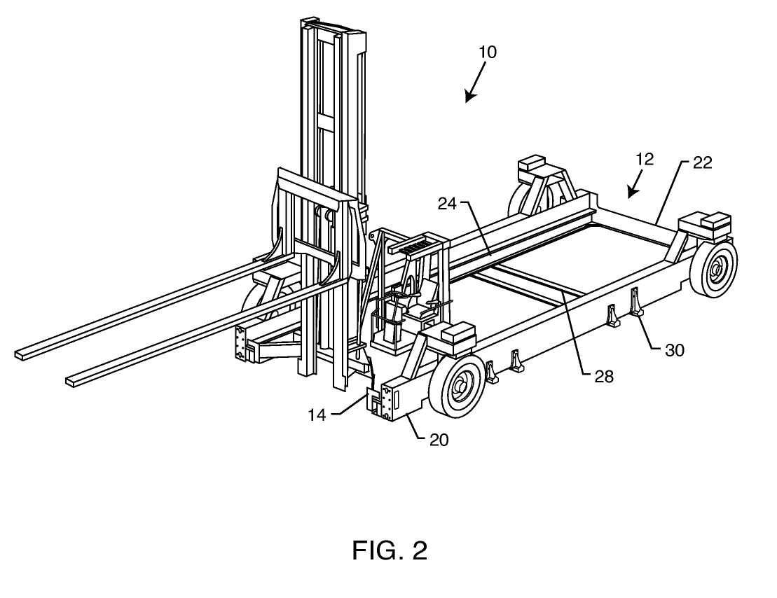

As shown in the exemplary drawings for purposes of illustration, the present invention relates to a gusseted torsion system for use with an open frame vehicle 10. The vehicle 10 is more particularly a boat lifting and stacking vehicle as described in U.S. application Ser. No. 11/877,174. As illustrated in FIGS.1 -3, the vehicle 10 generally consists of a U-shaped frame 12 and a carriage 14 carrying an upright forklift mast 16 and an operator console 18. The U-shaped frame 12 includes two generally parallel, load bearing beams 20, each connected to a rigid back plate 22 at one end. Guide rails 24 are mounted on an interior side of the beams 20 and wheel assemblies 26 are mounted on the beams 20 such that the wheels are on an exterior side of the beams 20. The carriage 14 rides along the guide rails 24 from back to front of the vehicle 10 and vice versa as illustrated in the difference between FIGS. 1 and 2.

The gusseted torsion system includes cross members 28 spanning the distance between the beams 20 beneath the open area bordered by the beams 20 and back plate 22. The cross members 28 are sufficiently below this open area to accommodate boats and other loads carried by the forklift mast 16. The open space also accommodates the carriage 14 as it moves along the guide rails 24. The cross members 28 must be sufficiently below the open area to permit movement of the carriage 14 along the rails 24. The cross members 28 generally are comprised of structural tubing or other structural members of sufficient strength to resist the force vectors and torsion vectors exerted on the U-shape frame 12.

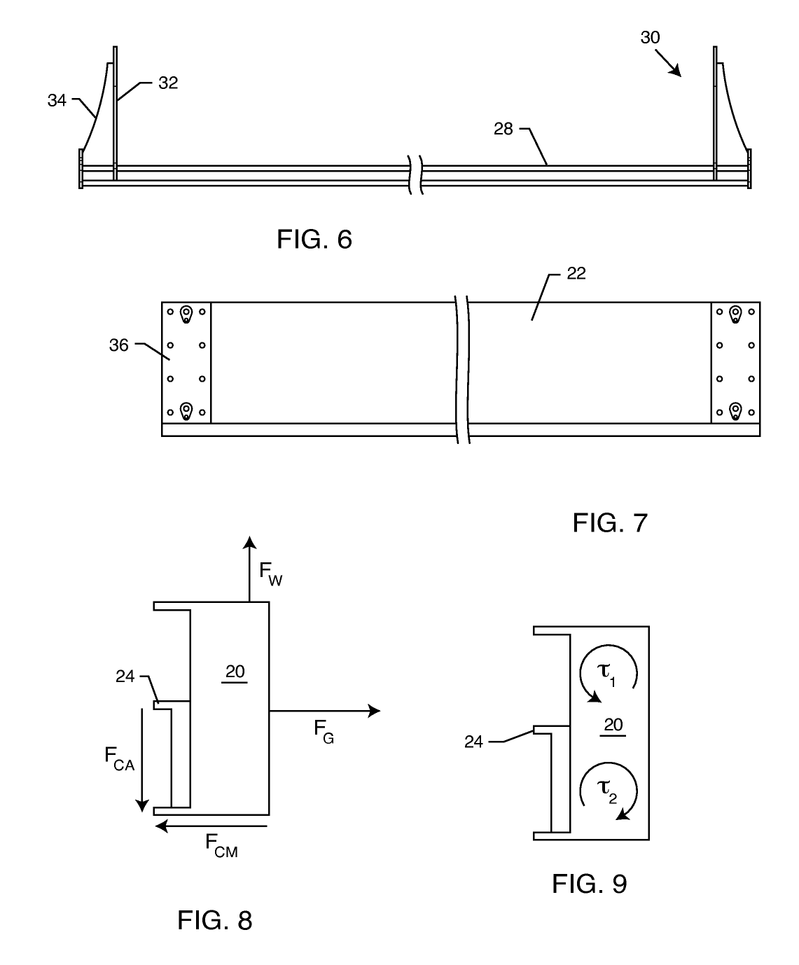

In FIG. 6, the gusseted torsion system further includes gussets 30 mounted on the ends of each of the cross members 28 and affixed to either an internal surface or external surface of the beams 20. As illustrated in the drawings, the preferred embodiment has the gussets 30 attached to the beams 20 on the external surface. The external surface is preferred as this keeps the internal open area of the frame 12 clear of obstructions. However, a person having ordinary skill in the art will realize that a gusset on either the internal or external surface of the beams will exert a force vector having the appropriate direction to counter the torsion forces as described below.

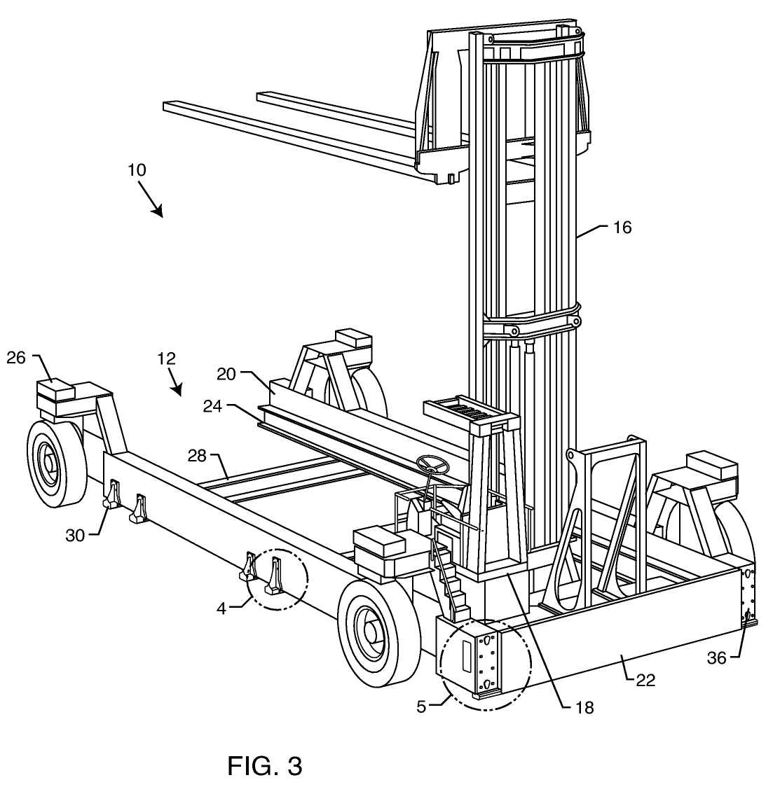

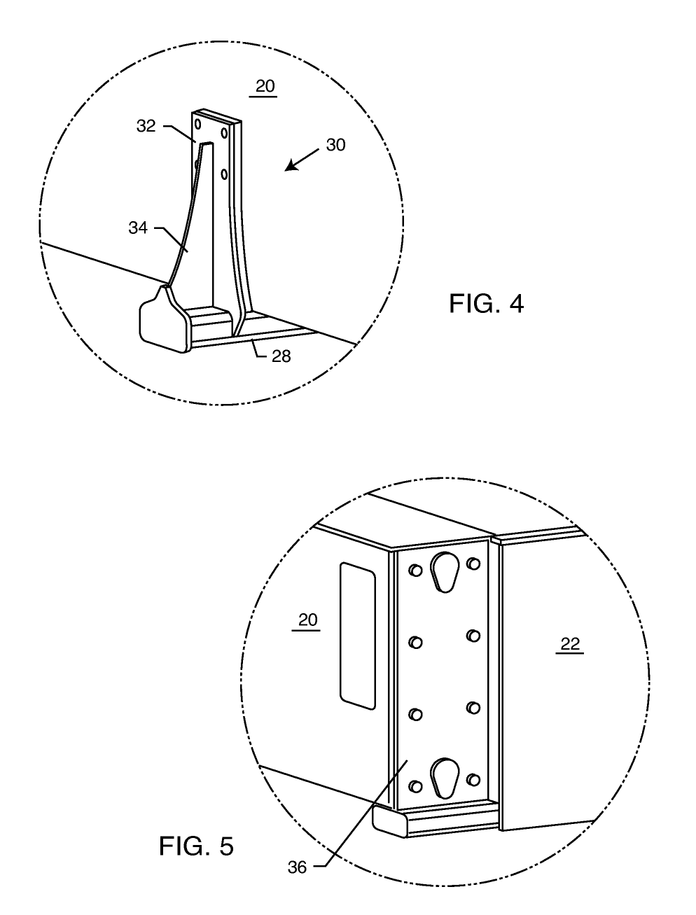

As illustrated in FIG. 4, the gussets 30 include a vertical plate 32 which is affixed to a surface of the beams 20. The gussets 30 also include a perpendicular gusset 34 which further anchors the vertical plate 32 to the cross member 28 to create the rigid structure necessary to counter the torsion forces. Multiple cross members 28 and gussets 30 are positioned along the U-shaped frame 12 at appropriate places to counter the torsion forces as the carriage 14 moves along the rails 24. The FIGS. 1-3 show four cross members 28 and four pairs of gussets 30 for illustration purposes only. The number and size of cross members 28 and pairs of gussets 30 should be calculated to provide the amount of force necessary to keep the open frame vehicle and the beams thereof vertical and parallel. This force and the amount of torsional deflection can be calculated based upon carriage and wheel load amounts to determine the amount of force necessary to counteract the torsional deflection.

In FIG. 7, the back plate 22 further includes rigid anchors 36 at each point where it connects to a beam 20. These rigid anchors 36 are designed to counteract the torsion forces at the rear of the U-shaped frame 12. A person having ordinary skill in the art will see that the cross members 28 and pairs of gussets 30 can be positioned a distance from this back plate 22 as the greater need to counter torsion forces exist closer to the open front of the U-shaped frame 12.

FIGS. 8 and 9 illustrate free body force and torsion diagrams of a cross-section of a beam 20 in the U-shaped frame 12. As shown in FIG. 8, force vector F_{W} represents the upward force created by the wheel assemblies 26 on the beam 20. Force vector F_{CA} represents the downward force vector created by the carriage 14 on the rails 24 mounted on the interior of the beam 20. The force vector F_{W} is applied to the exterior of the beam 20 and the force vector F_{CA} is applied to the interior of the beam 20. The action of these two force vectors create torsional force τ₁ in the beam 20. Torsion force τ₁ twists the top of each beam toward the interior of the U-shaped frame 12. Without additional support, this torsion vector τ₁ would twist the beams 20 inward and restrict motion of the carriage 14 as well as decrease clearance for any load carried by the forklift mast 16.

As further illustrated in FIG. 8, force vector F_{CM} illustrates the inwardly directed force created by the cross members 28 on the beams 20. Further, force vector F_{G} represents the outwardly directed forces exerted by the gussets 30 on the beams 20. Force vectors F_{CM} and F_{G} combine to keep the beams 20 of the U-shaped frame 12 parallel and also create torsion force τ₂ as illustrated in FIG. 9. This torsion force τ₂ creates an outward twisting force which counters the inward twisting force of τ₁. In this way the cross-members 28 and gussets 30 combine to form the gusseted torsion system for the open frame vehicle. The gusseted torsion system maintains the generally U-shaped frame 12 and the generally parallel relationship of the load bearing beams 20.

Although one preferred embodiment has been described in detail for purposes of illustration, various modifications may be made without departing from the scope and spirit of the invention. Accordingly, the invention is not to be limited, except as by the appended claims.

What is claimed is:

1. A gusseted torsion system for an open frame vehicle, comprising:
a generally U-shaped frame having two generally parallel, load-bearing beams and a back plate, the beams and back plate defining an open area;
a cross member extending between the beams below the open area; and
a gusset adjacent to each of two ends of the cross member and affixed to either a first side or an opposite second side of each of the beams.

2. The gusseted torsion system of claim 1, further comprising wheel supports on the first side of each of the beams and load bearing members on the opposite second side of each of the beams.

3. The gusseted torsion system of claim 2, wherein the first side is an external side of the beams and the opposite second side is an internal side of the beams.

4. The gusseted torsion system of claim 3, wherein each gusset is affixed to the external side of the beams.

5. The gusseted torsion system of claim 2, wherein the load bearing members comprise guide rails.

6. The gusseted torsion system of claim 5, further comprising a carriage mounted on the load bearing members, wherein the carriage is movable along the members from a back end of the beams to a front end of the beams and vice versa.

7. The gusseted torsion system of claim 1, wherein the back plate is rigidly connected to a back end of each of the beams.

8. The gusseted torsion system of claim 1, wherein each gusset is rigidly connected to the respective cross member at a ninety degree angle.

9. The gusseted torsion system of claim 1, wherein each gusset comprises a vertical plate rigidly connected to the first side or second side of the beams.

10. The gusseted torsion system of claim 9, wherein each gusset further comprises a perpendicular gusset that anchors the vertical plate to the adjacent cross member end.

11. A gusseted torsion system for an open frame vehicle, comprising:
a generally U-shaped frame having two generally parallel, load-bearing beams and a back plate, the beams and back plate defining an open area;
wheel supports on an external side of each of the beams and load bearing members on an internal side of each of the beams;
a cross member extending between the beams below the open area; and
a gusset adjacent to each of two ends of the cross member and affixed to either the external side or the internal side of each of the beams.

12. The gusseted torsion system of claim 11, wherein each gusset is affixed to the external side of the beams.

13. The gusseted torsion system of claim 11, wherein the load bearing members comprise guide rails.

14. The gusseted torsion system of claim 13, further comprising a carriage mounted on the load bearing members, wherein the carriage is movable along the members from a back end of the beams to a front end of the beams and vice versa.

15. The gusseted torsion system of claim 11, wherein the back plate is rigidly connected to a back end of each of the beams.

16. The gusseted torsion system of claim 11, wherein each gusset is rigidly connected to the respective cross member at a ninety degree angle.

17. The gusseted torsion system of claim 11, wherein each gusset comprises a vertical plate rigidly connected to the first side or second side of the beams.

18. The gusseted torsion system of claim 17, wherein each gusset further comprises a perpendicular gusset that anchors the vertical plate to the adjacent cross member end.

19. A gusseted torsion system for an open frame forklift vehicle, comprising:
a generally U-shaped frame having two generally parallel, load-bearing beams and a back plate, the beams and back plate defining an open area;
a cross member extending between the beams below the open area; and
a gusset adjacent to each of two ends of the cross member rigidly connected to the cross member at a ninety degree angle, wherein each gusset comprises a vertical plate rigidly connected to a first side or an opposite second side of the beams and a perpendicular gusset that anchors the vertical plate to the adjacent cross member end.

20. The gusseted torsion system of claim 19, further comprising wheel supports on the first side of each of the beams and load bearing members on the opposite second side of each of the beams.

21. The gusseted torsion system of claim 20, wherein the first side is an external side of the beams and the opposite second side is an internal side of the beams.

22. The gusseted torsion system of claim 21, wherein each gusset is affixed to the external side of the beams.

23. The gusseted torsion system of claim 20, wherein the load bearing members comprise guide rails.

24. The gusseted torsion system of claim 23, further comprising a carriage mounted on the load bearing members, wherein the carriage is movable along the members from a back end of the beams to a front end of the beams and vice versa.

25. The gusseted torsion system of claim 19, wherein the back plate is rigidly connected to a back end of each of the beams.
